(19) United States
(12) Patent Application Publication
(10) Pub. No.: US 2009/0197185 A1
(43) Pub. Date: Aug. 6, 2009

(54) DOCUMENT RECORDING METHOD AND APPARATUS

(75) Inventors: Katsunori KAWANO, Kanagawa (JP); Kazuhiro HAYASHI, Kanagawa (JP); Makoto FURUKI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/258,967

(22) Filed: Oct. 27, 2008

(30) Foreign Application Priority Data
Feb. 5, 2008 (JP) 2008-024890

(51) Int. Cl. G03H 1/04; G03H 1/00

(52) U.S. Cl. 430/1; 359/1

(57) ABSTRACT

A document recording method for recording a document on a microfilm, the document including a series of pages, a format of which is specified so as to include at least a page representing commencement, a page representing an original, and a page representing conclusion. The method includes recording all or a portion of the series of pages on the microfilm in a hologram format that is obtained by interference between object light and reference light.

### CROSS-REFERENCE TO RELATED APPLICATION

This application is based on and claims priority under 35 USC 119 from Japanese Patent Application No. 2008-024890 filed Feb. 5, 2008.

### BACKGROUND

1. Technical Field

The present invention relates to a document recording method and apparatus.

2. Related Art

Heretofore, for long-term storage of documents, such as preservation of public documents and the like, recording media known as microfilms, microfiches and the like (below referred to as microfilms, etc.) have been used. In microfilms, etc., silver salt photosensitive materials, whose preservation characteristics are excellent, are generally used. Consequently, microfilms at which documents are recorded (below referred to as microfilm documents) are capable of long-term storage over 100 years or more.

On microfilms, etc., reduced images (usually positive images) of respective papers (pages) included in a document are sequentially recorded in an analog format on a single film or a single sheet, with frame numbers assigned to the respective pages or the like. When document information is to be read from a microfilm document, a document to be viewed and a page to be viewed are specified by a frame number, and the reduced image that has been recorded is optically magnified and shown at the display.

Microfilm documents have advantages in visual readability allowing interpretation when they are optically magnified, in being capable of fundamentally preventing tampering, and so forth. In practical terms, microfilm documents, with the characteristic of information being reproduced as is, with formats being internationally regulated and standardized by JIS, ISO and the like, and so forth, have high reliability and suchlike. For these reasons, microfilm documents have effectiveness as legal evidence (evidentiary quality) equivalent to original documents, and this has been substantiated by precedents in Japan and other countries.

In order to guarantee authenticity of a document in, for example, recording and preservation of public documents using microfilms, a resolution chart, photography commission, case title, details, photography certification and suchlike are placed before and after the document to be preserved (pages representing the original (the original document, body contents)), and the original is recorded on a microfilm sandwiched by this information. Thus, a format is established so as to include at least pages representing commencement, pages representing the original and pages representing conclusion. Thus, unless the film is actually cut-and-pasted, evidentiary quality of a document which includes a series of pages is guaranteed.

However, microfilms, etc., with which images of pages of documents are reduced and recorded, have limits on recording volumes. For example, a microfilm employed in accordance with standards is a roll film with a width of 16 mm and a length of 66 m. If pages are photographed and recorded thereon at a reduction of 1/40, only about 6,000 pages can be recorded on one film. In addition, because microfilms record document information in analog formats, problems in usability have been identified with regard to searchability, such as keyword searches not being possible and the like.

Meanwhile, in recent years, computerization (digitalization, electronization) of document information recorded in analog formats such as paper documents, microfilm documents, etc. has been progressing. Advantages arising from computerization include: 1) with electronic data, different categories of document information such as paper documents, microfilm documents, electronic documents, etc. may be administered together; 2) transfers and distributions of document information within businesses may be smoothly implemented; 3) document information from microfilm documents may be effectively utilized in the form of easily accessible data on a computer; and so forth.

However, a problem has arisen in that the evidentiary quality of documents is lost in computerization. Document data recorded in an analog format has high authenticity due to being analog. Once this document data is digitalized, tampering is made easier, and as a result evidentiary quality is lost. In other words, it is difficult to provide both the “convenience of digital” and the “evidentiary quality of analog”.

### SUMMARY

In consideration of the above circumstances, the present invention provides a document recording method and apparatus.

According to an aspect of the invention, there is provided a document recording method for recording a document on a microfilm, the document including a series of pages for which a format is specified so as to include at least a page representing commencement, a page representing an original, and a page representing conclusion, the method including: recording all or a portion of the series of pages on the microfilm in a hologram format obtained by interference between object light and reference light.

### BRIEF DESCRIPTION OF THE DRAWINGS

Exemplary embodiments of the present invention will be described in detail based on the following figures, wherein:

FIG. 1A and FIG. 1B are views showing the form of a type of microfilm.

FIG. 1C is a view showing the form of a type of microfilm.

FIG. 2 is a diagram showing the constitution of a recording region of a microfilm.

FIG. 3A to FIG. 3C are diagrams showing an example of a format of a microfilm document.

FIG. 4 is a conceptual diagram for explaining a document recording method relating to a first exemplary embodiment.

FIG. 5 is a schematic diagram showing structure of a document recording apparatus relating to the first exemplary embodiment.

FIG. 6 is a diagram describing a replaying method of a hologram recorded by the document recording method relating to the first exemplary embodiment.

FIG. 7 is a conceptual diagram for explaining a variant example of the document recording method relating to the first exemplary embodiment.

FIG. 8 is a conceptual diagram for explaining a document recording method relating to a second exemplary embodiment.

FIG. 9 is a schematic diagram showing structure of a document recording apparatus relating to the second exemplary embodiment.

FIG. 10 is a diagram describing a replaying method of a hologram recorded by the document recording method relating to the second exemplary embodiment.

FIG. 11 is a conceptual diagram for explaining a variant example of the document recording method relating to the second exemplary embodiment.

### DETAILED DESCRIPTION

Herebelow, exemplary embodiments of the present invention will be described in detail with reference to the drawings.

### —Microfilm—

The microfilm is a photographic film for recording miniature (reduced) photographs of information in paper documents and the like. For miniature photography, a higher resolution than with ordinary photographic film is provided and recording of larger amounts of information in a smaller area is enabled. The microfilm is structured to include at least a film-form substrate and a photosensitive recording layer formed on the substrate. As the film-form substrate, ordinarily, a transparent resin film of triacetyl cellulose (TAC), polyethylene terephthalate (PET) or the like is used.

A photosensitive material for photographic films is used in the photosensitive recording layer. In the present invention, holograms are recorded in the microfilm. Accordingly, the photosensitive material that is used in the photosensitive recording layer of the microfilm may be any kind of photosensitive material as long as holograms can be recorded therein; silver salt photosensitive materials, which have excellent preservation characteristics, are excellent. With a microfilm using a silver salt photosensitive material such as a silver halide emulsion or the like, long-term preservation characteristics over 100 years or more are assured.

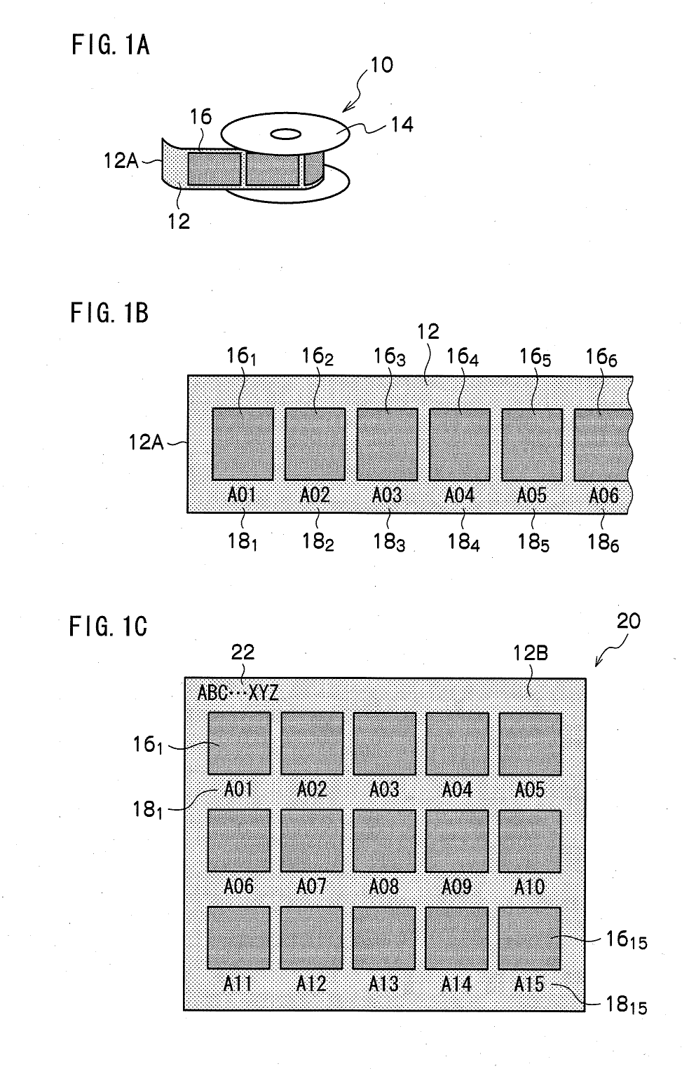

FIG. 1A to FIG. 1C are diagrams showing forms of kinds of microfilm. Microfilms are broadly divided into roll-form roll films and sheet-form sheet films. FIG. 1A and FIG. 1B are views showing an example of a roll film, and FIG. 1C is a diagram showing an example of a microfiche, which is a type of sheet film.

As shown in FIG. 1A, a roll film 10 is provided with a strip-form film 12. One end of the film 12 is fixed to a reel 14, and the film 12 is wound round the reel 14. An other end 12A of the film 12 serves as a free end. As shown in FIG. 1B, numerous frames 16, which are recording regions of the film 12, are arrayed along a length direction of the film. A frame number 18, which indicates where in the sequence a frame is, is assigned to each of the frames 16.

In this example, six frames 16₁ to 16₆ are illustrated, arrayed from the other end 12A end of the film 12. Below the respective frames 16₁ to 16₆, frame numbers 18₁ to 18₆ are recorded. For example, the frame number 18₁ of the first frame 16₁ is “A01”, and the frame number 18₃ of the third frame 16₃ is “A03”. After document information has been recorded onto the microfilm, the frames (regions) 16 at which the document information is recorded are identified from the frame numbers 18.

As shown in FIG. 1C, a microfiche 20 is provided with a sheet-form film 12B. The sheet-form film 12B is a film with a rectangular shape in plan view. The frames 16 which are recording regions are numerously arrayed in a matrix on the film 12B. The frame numbers 18, indicating where in the sequence the frames are, are assigned to the respective frames 16. A heading section 22 is disposed at an upper portion of the film 12B. The heading section 22 records indexing information, such as a title of the recorded document, a date of recording and the like.

In this example, fifteen frames 16₁ to 16₁₅ are illustrated on the film 12B of the microfiche 20. The fifteen frames 16₁ to 16₁₅ are arrayed in a matrix of three rows by five columns. Below the respective frames 16₁ to 16₁₅, the frame numbers 18₁ to 18₁₅ are recorded. For example, the frame number 18₁ of the first frame 16₁ is “A01”, and the frame number 18₁₅ of the fifteenth frame 16₁₅ is “A15”. A heading, “ABC . . . XYZ”, is recorded at the heading section 22.

A roll film employed in accordance with standards has a width of 16 mm and a length of 66 m. When document information is recorded in an analog format on this roll film, about 6,000 pages may be recorded on one film at a reduction ratio of 1/40. A microfiche that is employed in accordance with standards has a size of the order of A6 size, and may be for 60 frames, for 98 frames, for 244 frames or for 270 frames.

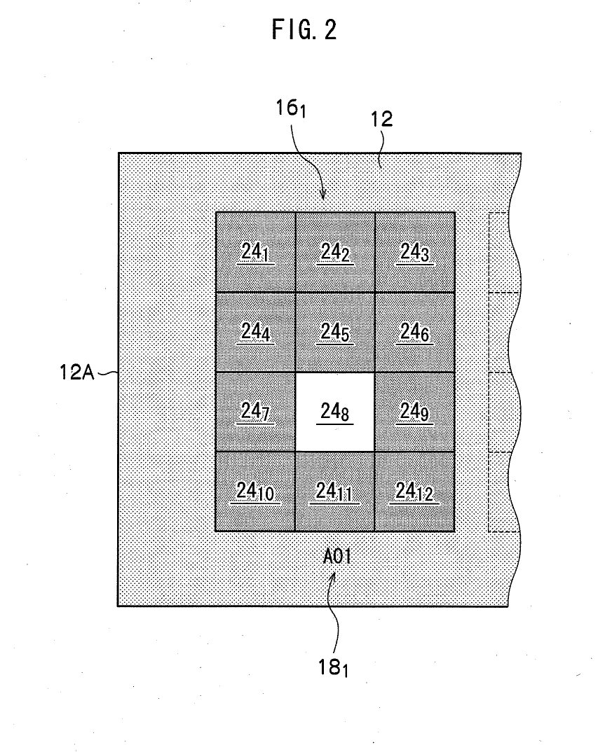

FIG. 2 is a diagram showing the constitution of a recording region of a microfilm. Here, for the roll film 10 shown in FIG. 1A, detailed constitution of the frame 16₁, the first recording region, is illustrated. Conventionally, a reduced image corresponding to a single page has been recorded in an analog format in one frame of a microfilm. In the present invention, document information is recorded in a hologram format on a microfilm. When document information is recorded in a hologram format, the area of the recording region can be made smaller than when recording in an analog format, and a recording capacity of the microfilm is increased. If a Fourier transform hologram is recorded, in which an image is Fourier-transformed by a lens and recorded, rather than a Fresnel hologram in which an image is imaged without alteration, the area of the recording region may be made smaller, due to condensation by the lens.

Therefore, when document information is recorded in a hologram format, a single frame may be divided into plural sectors and different document information may be recorded at each sector. A single frame is divided into plural sectors by a method that enables optical distinction between adjacent sectors, by the provision of partition lines or suchlike.

Furthermore, when document information is recorded in a hologram format, document information corresponding to a plural number of pages may be recorded by multiplexing in a single sector. For example, a series of pages may be recorded by angle multiplexing in exactly the same location, by altering the incidence angle of reference light for each page. Alternatively, shift multiplexing recording may be implemented, in which the film is moved slightly after a hologram corresponding to one page has been recorded, and a hologram of the next page is recorded so as to almost completely overlap with the hologram of the previous page.

In this example, the frame 161, which is the first recording region of the film 12, is divided into twelve sectors 24₁ to 24₁₂ by boundary lines. The twelve sectors 24₁ to 24₁₂ are arrayed in a matrix of four rows by three columns. As an example, document information of a plural number of pages may be multiplex-recorded as holograms in the sector 24₈, in the third row, second column of the frame 16₁ (the region shown in white). As mentioned above, a multiplex-recording method such as angle multiplexing recording, shift multiplexing recording or the like may be utilized. Hereinafter, where it is not necessary to particularly distinguish between the respective sectors 24₁ to 24₁₂, general reference is made to a sector 24.

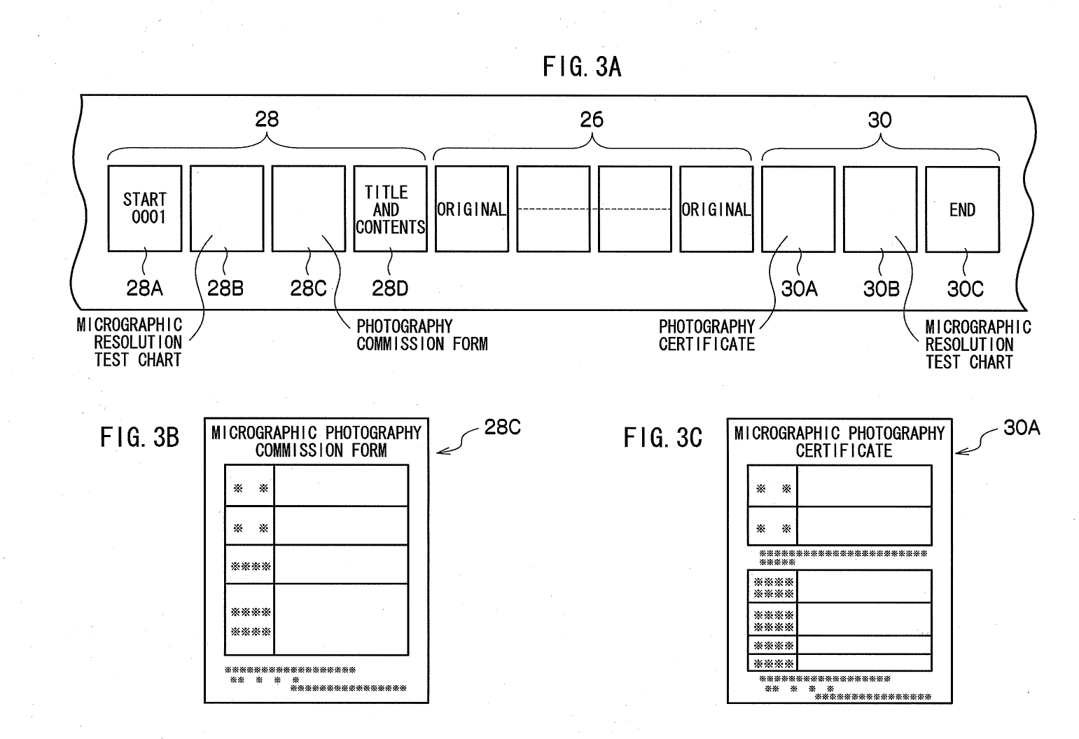

FIG. 3A to FIG. 3C are diagrams showing a format of a microfilm document. Formats of microfilm documents are internationally regulated and standardized by JIS, ISO and the like in order to have effectiveness as legal evidence (evidentiary quality) equivalent to original documents. For example, in the microfilm document administering standards specified by the Japan Image and Information Management Association, a microfilm document is defined as being a microfilm at which an original document such as a paper document or the like is photographed, and as being a master film document and active films.

Herein, the term “master film document” means a microfilm for which effectiveness as legal evidence is guaranteed, being a microfilm which is preserved by an administration manager for preservation, duplication of active film documents and the like. Further, the term “active film” means a microfilm duplicated from a master film, being a microfilm which is preserved by an administration manager.

In the above-mentioned microfilm document administering standards, a format of microfilm documents is specified to include pages representing commencement, pages representing the original, and pages representing conclusion. For example, in a case in which a microfilm document is concluded in a single roll film, as shown in FIG. 3A, pages representing commencement 28 are disposed to precede pages representing the original 26, and pages representing conclusion 30 are disposed to succeed the pages representing the original 26. When such a format is employed, unless the film is cut-and-pasted, evidentiary quality of the microfilm document is assured.

The pages representing commencement 28 include pages of a start indicator (“Start 0001”) 28A, a resolution chart (a micrographic resolution test chart) 28B, a photography commission form (micrographic photography commission form) 28C and a title and contents 28D. The pages representing conclusion 30 include pages of a photography certificate (micrographic photography certificate) 30A, a resolution chart (a micrographic resolution test chart) 30B, and an end indicator (“End”) 30C. FIG. 3B is a diagram showing a specific example of the above-mentioned photography commission form 28C, and FIG. 3C is a diagram showing a specific example of the above-mentioned photography certificate 30A.

Herebelow, a document recording method and apparatus that create a microfilm document will be concretely described. The document recording method and apparatus record the whole or a portion of a document includes a series of pages, whose format is specified as described above, on a microfilm in a hologram format, which is obtained by interference of object light with reference light, rather than in an analog format in which images of pages are reduced and recorded. Hereafter, a case in which the roll film 10 is used is illustrated, being referred to as the microfilm 10.

A hologram is a recording of an interference pattern of two light waves and, even to the point of destruction, deliberate tampering therewith is difficult. In particular, deliberate tampering with a portion of a group of holograms that have been multiplex-recorded (for example, holograms corresponding to particular pages) is not possible. Therefore, by recording the whole or a portion of a series of pages whose format is specified on a microfilm in a hologram format, authenticity of a document is not impaired (tampering is prevented and evidentiary quality is assured), and document information in larger volumes than in a case of recording in an analog format can be recorded and preserved over long periods.

### First Exemplary Embodiment

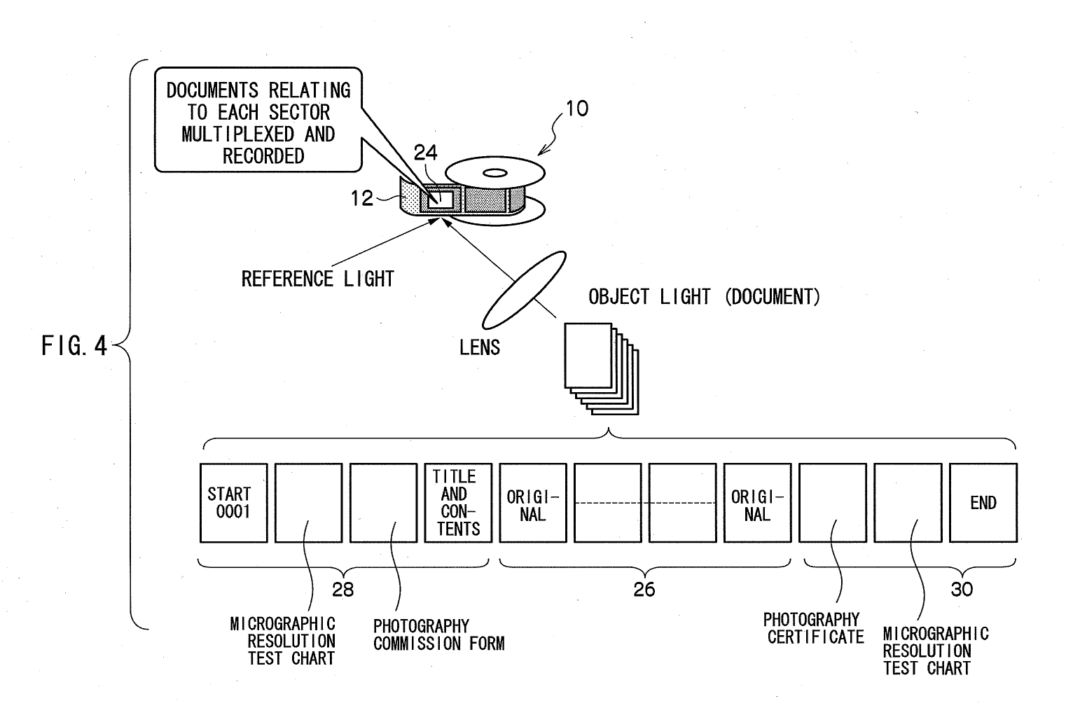

In the first exemplary embodiment, an example is described in which, as shown in FIG. 4, the whole of a series of pages whose format is specified for a microfilm document (the pages representing commencement 28, the pages representing the original 26 and the pages representing conclusion 30) are multiplex-recorded in the same sector 24 of the microfilm 10, in a format of analog data holograms. Herein, the term “analog data hologram” means a hologram recorded by interference of a reflected object light, obtained by reflecting light from a document to be recorded, with a reference light. By recording on the microfilm in the hologram format, the recording capacity of the microfilm is made greater than in a case of recording in an analog format.

When an analog data hologram is illuminated, with a reference light the same as at the time of recording serving as a reading light, the reflected object light from the hologram is replayed. When the replayed reflected object light is focused, an analog image of the recorded page is imaged. That is, when recording is done in the format of an analog data hologram, an analog image is replayed. In other words, for an analog data hologram, a hologram of a page is directly photographed and recorded, and prevention of tampering and assurance of evidentiary quality are facilitated.

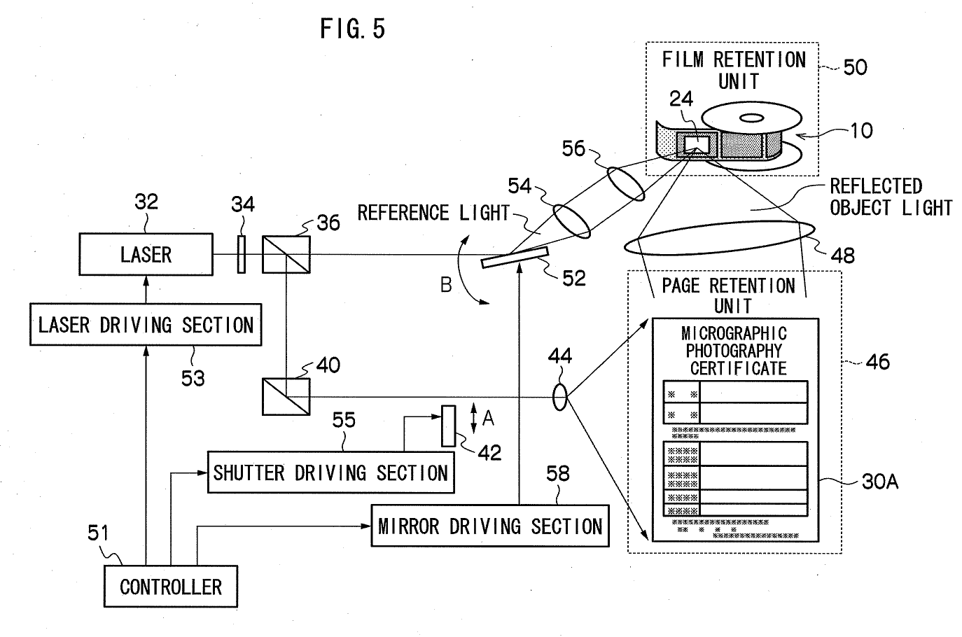

FIG. 5 is a schematic diagram showing structure of a document recording apparatus relating to the first exemplary embodiment.

In this document recording apparatus, a light source 32 is provided which oscillates with laser light, which is coherent light. As the light source 32, for example, a laser light source that oscillates with green laser light with an oscillation wavelength of 532 nm is used. The document recording apparatus is also provided with a controller 51 that controls respective sections of the document recording apparatus. The light source 32 is driven by a laser driving section 53 connected to the controller 51. At the light emission side of the light source 32, a wave plate 34 and a polarizing beam splitter 36 are arranged in this order along a light path away from the light source 32. The wave plate 34 provides a predetermined light path difference (phase difference) between orthogonal linear polarization components of a specified wavelength. The polarizing beam splitter 36 reflects light with a predetermined polarization direction and transmits light with a polarization direction orthogonal thereto. A reflection mirror 40 is disposed at the light reflection side of the polarizing beam splitter 36. At the light reflection side of the reflection mirror 40, a shutter 42 and a beam expander 44 are arranged in this order along the light path away from the reflection mirror 40. The shutter 42 can be moved into and withdrawn from (open and close) the light path. The beam expander 44 is a magnifying and collimating optical system. The shutter 42 is opened and closed (moved in the directions of arrow A) by driving by a shutter driving section 55, which is connected to the controller 51.

A page retention unit 46 is provided at the light emission side of the beam expander 44. The page retention unit 46 retains a page of an original document that is to be photographed, such as a paper document. Pages of the original document are conveyed one at a time by an unillustrated feeding mechanism, and are sequentially retained at the page retention unit 46. Light emitted from the beam expander 44 is irradiated at the whole of the page retained at the page retention unit 46 (for example, the photography certificate 30A shown in FIG. 3C). The object light is reflected or dispersed from the document retained at the page retention unit 46 (reflected object light). At the reflected object light emission side, a Fourier transform lens 48 is disposed. The Fourier transform lens 48 Fourier-transforms the reflected object light and focuses the same on a predetermined location (the sector 24) of the microfilm 10, which is retained by a film retention unit 50.

At the light transmission side of the polarizing beam splitter 36, a wave plate 38, a turnable mirror 52 that turns about a predetermined axis, and a pair of relay lenses 54 and 56 are disposed. The turnable mirror 52 is driven to turn (turning in the directions of arrow B) by a mirror driving section 58 connected to the controller 51. The pair of relay lenses 54 and 56 relay light reflected by the turnable mirror 52 and irradiate the light, onto the predetermined location (the sector 24) of the microfilm 10 retained at the film retention unit 50, to serve as reference light.

Next, a recording operation of the document recording apparatus shown in FIG. 5 will be described.

When a hologram is to be recorded, the shutter 42 is opened and laser light is irradiated from the light source 32. The laser light oscillated from the light source 32 is regulated in polarization direction by the wave plate 34, is incident on the polarizing beam splitter 36, and is split. The light that has been reflected by the polarizing beam splitter 36 is reflected by the reflection mirror 40.

Light that has been reflected by the reflection mirror 40 and whose light path has been bent passes through the shutter 42, is converted to parallel light with a large diameter by the beam expander 44, and is irradiated at the whole of the page retained at the page retention unit 46. The object light is reflected or dispersed from the page retained at the page retention unit 46 (reflected object light). The reflected object light is Fourier-transformed and focused by the Fourier transform lens 48, and is irradiated onto the predetermined location (the sector 24) of the microfilm 10 retained at the film retention unit 50.

Meanwhile, the light that has transmitted through the polarizing beam splitter 36 is regulated in polarization direction by the wave plate 38, and is reflected by the turnable mirror 52, in a predetermined direction in accordance with a turn angle of the turnable mirror 52. The light reflected by the turnable mirror 52 is relayed by the pair of relay lenses 54 and 56, and is irradiated at the predetermined location (the sector 24) of the microfilm 10 retained at the film retention unit 50 to serve as the reference light. The reference light is irradiated onto the predetermined location (the sector 24) simultaneously with the reflected object light. At the location at which the reflected object light and the reference light are irradiated, the reflected object light and the reference light interfere, and an interference pattern that is formed is recorded as an analog data hologram.

If, for example, the polarizing beam splitter 36 is structured so as to reflect S-polarized light and transmit P-polarized light, the polarization direction of the laser light is controlled by the wave plate 34, and is split between two light paths by the polarizing beam splitter 36. The light reflected by the polarizing beam splitter 36 (the S polarization) proceeds to the reflection mirror 40, and reflected object light with the S polarization is irradiated onto the sector 24. Meanwhile, the light transmitted through the polarizing beam splitter 36 (the P polarization) is converted to the S polarization by the wave plate 38, and reference light with the S polarization is irradiated at the sector 24. Here, an intensity ratio between the reference light and the reflected object light is adjusted by adjustment of the polarization direction at the wave plate 34.

In the present exemplary embodiment, as described above, the whole of a series of pages (the pages representing commencement 28, the pages representing the original 26 and the light source 32) is photographed, and recorded one sheet at a time in the analog data hologram format at the same sector 24 of the microfilm 10 (see FIG. 4). The photographed pages of the original document are conveyed one at a time by the unillustrated feeding mechanism and are sequentially retained at the page retention unit 46. Reflected object light and reference light are interfered for each page, and an analog data hologram is recorded for each page. Because, for example, the incidence angle of the reference light for each page is altered by the turnable mirror 52 being turned, angle multiplexing recording of the whole of the series of pages may be carried out at the same recording region (for example, the sector 24) of the microfilm 10.

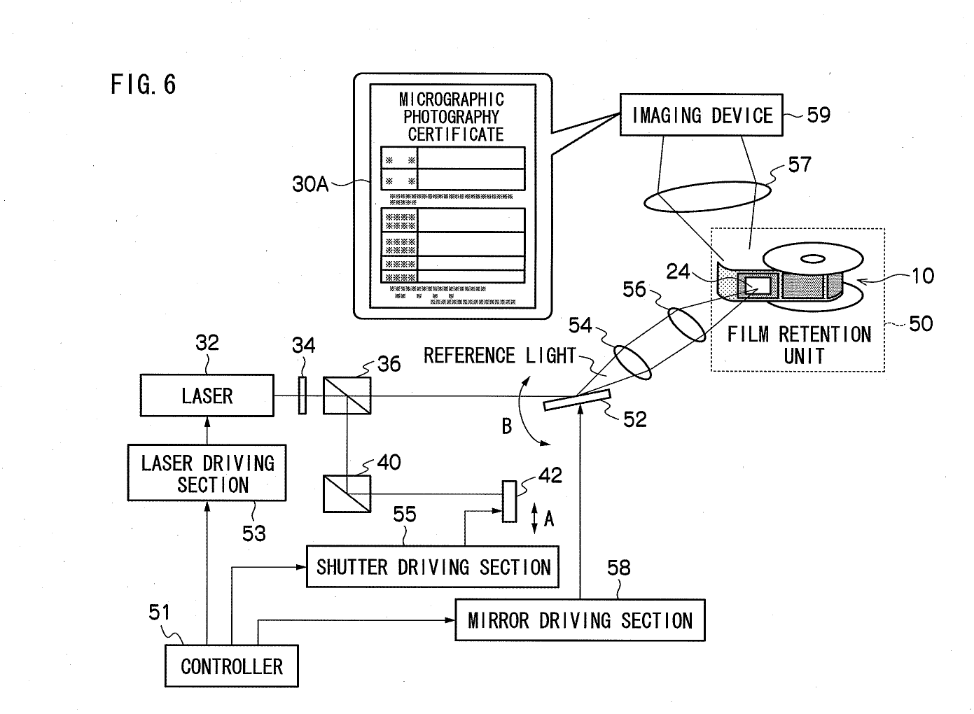

When the recorded data is to be read (replayed), as shown in FIG. 6, a Fourier transform lens 57 and a sensor array 59 are disposed at a light transmission side of the microfilm 10. The sensor array 59 is structured with an imaging device such as a CCD, a CMOS array or the like. The shutter 42 is closed, and laser light is irradiated from the light source 32. The laser light that is oscillated from the light source 32 is regulated in polarization direction by the wave plate 34, and is incident on the polarizing beam splitter 36. Here, the wave plate 34 is suitably adjusted such that all the light is guided into the reference light path or such that a suitable reference light intensity is set.

The light transmitted through the polarizing beam splitter 36 (P-polarized light) is converted to the S polarization by the wave plate 38, and is reflected by the turnable mirror 52 in a predetermined direction according to the turn angle of the turnable mirror 52. The light reflected by the turnable mirror 52 is relayed by the pair of relay lenses 54 and 56, and is irradiated at a recording region of the microfilm 10 retained at the film retention unit 50, as reference light for reading. Because the shutter 42 is moved into the light path at the time of replay, even if there is light reflected by the polarizing beam splitter 36, the reference light alone may be irradiated at the recording region (the sector 24) of the microfilm 10.

When the irradiated reference light passes through the recording region of the microfilm 10, it is diffracted by the recorded hologram, and the transmitted and diffracted light is transmitted toward the Fourier transform lens 57. The transmitted and diffracted light is reverse Fourier-transformed by the Fourier transform lens 57, and the reflected object light is replayed. The replayed reflected object light is incident on the sensor array 59. At a surface of the sensor array 59, the reflected object light is focused, and an analog image of the page is imaged. The sensor array 59 converts detected light to electronic signals, and outputs the same. Thus, the analog image of the page is formed.

If analog data holograms of a plural number of pages have been multiplex-recorded at the recording region (sector 24) of the microfilm 10, reference light that is the same as when the analog data hologram of a page that is to be read (for example, the photography certificate 30A) was recorded is irradiated. For example, if analog data holograms of a plural number of pages have been recorded by angle multiplexing, the turn angle of the turnable mirror 52 is adjusted, and the reference light is irradiated at the recording region of the microfilm 10 with an incidence angle the same as when the analog data hologram of the photography certificate 30A was recorded. Accordingly, an analog image of the photography certificate 30A is replayed.

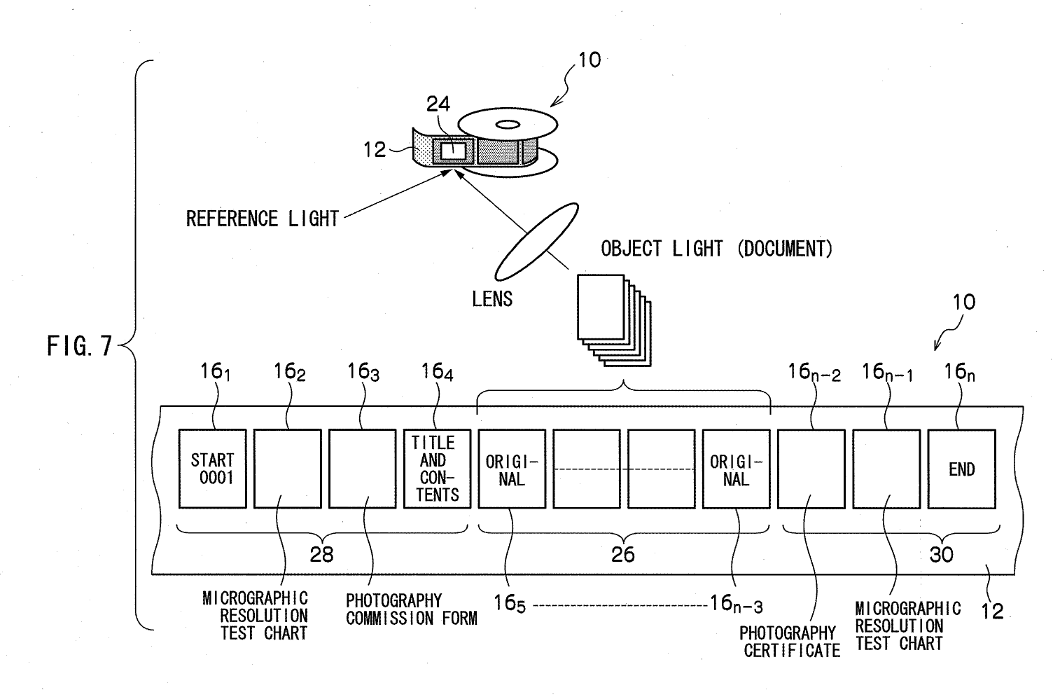

For the above-described first exemplary embodiment, an example has been described in which the whole of a series of pages (the pages representing commencement 28, the pages representing the original 26 and the pages representing conclusion 30) are multiplex-recorded on the same sector 24 of the microfilm 10 in the format of analog data holograms. However, as shown in FIG. 7, a portion of a series of pages (the pages representing commencement 28 and the pages representing conclusion 30) may be recorded on the microfilm 10 in an analog format in which images of pages are reduced and recorded, as in convention. In the analog format, one page is recorded in each of the frames 16.

Between the frames of the pages representing commencement 28 and the frames representing the pages representing conclusion 30, just the pages representing the original 26 may be multiplex-recorded in the format of analog data holograms in the same recording region of the microfilm 10 (the sector 24). For example, as shown in FIG. 7, the pages representing commencement 28 may be recorded in the analog format in frames 16₁ to 16₄, the pages representing conclusion 30 recorded in the analog format in frames 16ₙ₋₂ to 16ₙ, and the pages representing the original 26 (the plural number of pages) multiplex-recorded in the format of analog data holograms in the sectors 24 that are present in any of frames 16₅ to 16ₙ₋₃ sandwiched between the frame 16₄ and the frame 16ₙ₋₂.

Because the pages that are appended in order to assure evidentiary quality of the microfilm document (i.e., the pages representing commencement 28 and the pages representing conclusion 30) are recorded on the microfilm 10 in the analog format which can be directly interpreted, tampering is more difficult in respect of visual readability. In addition, because the pages representing the original 26 are multiplex-recorded at the same sector 24 of the microfilm 10 in the format of analog data holograms, tampering is prevented and evidentiary quality is assured, and document information in larger volumes than in a case of recording in the analog format may be recorded and preserved over long periods.

### Second Exemplary Embodiment

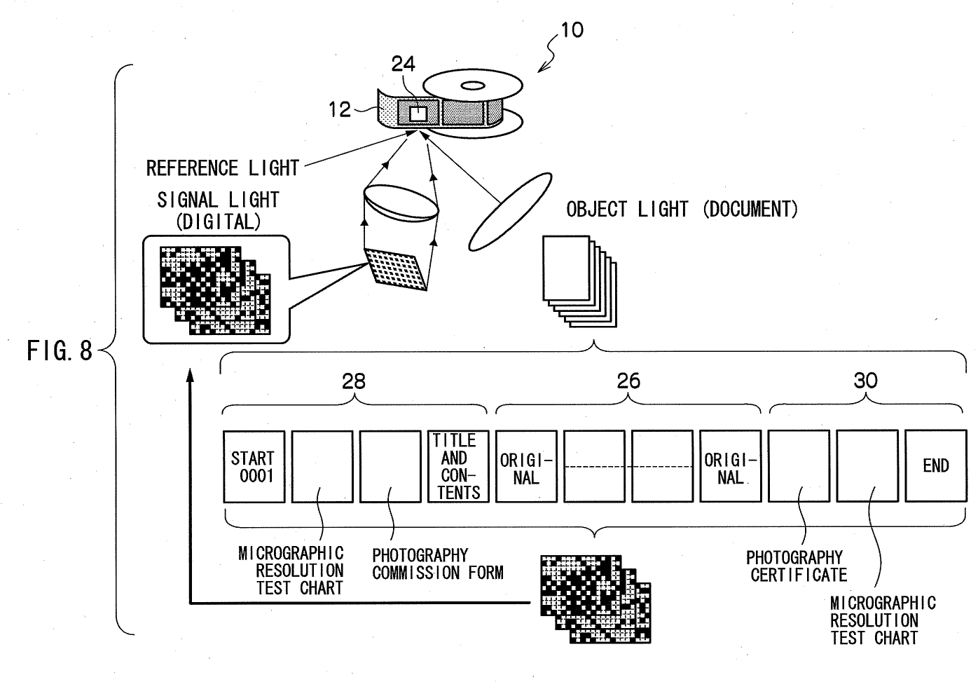

In the second exemplary embodiment, an example is described in which, as shown in FIG. 8, the whole of a series of pages whose format is specified for microfilm documents (the pages representing commencement 28, the pages representing the original 26 and the pages representing conclusion 30) are multiplex-recorded in the same sector 24 of the microfilm 10, in the format of an analog data hologram and in the format of a digital data hologram, for each page.

Herein, the term “digital data hologram” means a hologram recorded by interference between signal light and reference light, the signal light being modulated in accordance with a digital image that represents the document information of a page to be recorded in a (two-dimensionally encoded) bright-dark image. The digital image may be a digital image in which bit information is arranged in two dimensions in accordance with digital data, a two-dimensional bar code to correspond with digital data, or the like. Recording on the microfilm in the hologram format is similar to the first exemplary embodiment in that the recording capacity of the microfilm is increased relative to a case of recording in an analog format.

With a digital data hologram, when reference light the same as at the time of recording is irradiated as reading light, signal light is replayed from the digital data hologram. When the replayed signal light is focused, a digital image of the recorded page is imaged. That is, when recording is done in the format of a digital data hologram, a digital image is replayed. The digital image is decoded to digital data (computerized document information of a page). Thus, the convenience of digital—unified administration of document information, transfers and distribution of document information, effective utilization of document information, searchability and the like—may be obtained. Therefore, by recording the same page as both an analog data hologram and a digital data hologram in association with one another, such that both an analog image of the page is replayed and digital data of the page is replayed, the “convenience of digital” and the “evidentiary quality of analog” can both be provided.

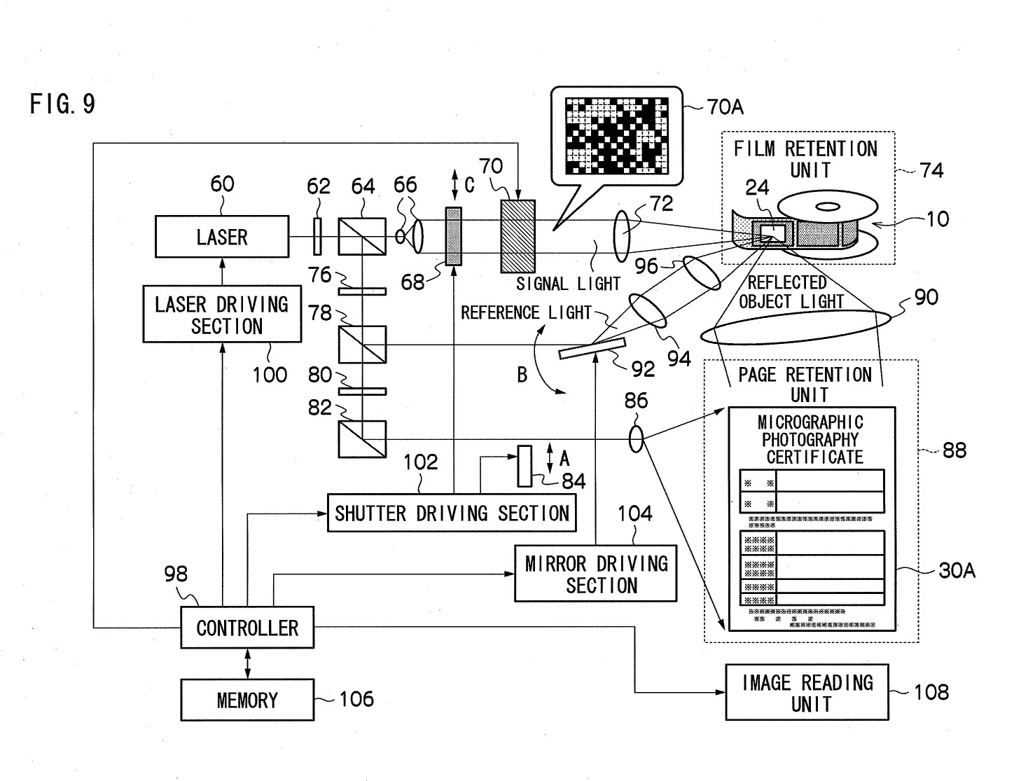

FIG. 9 is a schematic diagram showing structure of a document recording apparatus relating to the second exemplary embodiment.

In this document recording apparatus, a light source 60 is provided which oscillates with laser light, which is coherent light. As the light source 60, for example, a laser light source that oscillates with green laser light with an oscillation wavelength of 532 nm is used. The document recording apparatus is also provided with a controller 98, which controls respective sections of the document recording apparatus, and a memory 106 for memorizing various kinds of data. The controller 98 may be constituted by, for example, a microcomputer equipped with a CPU, ROM and RAM, or the like. The memory 106 may be structured with a hard disk apparatus (HDD) or the like that is provided to serve as an external memory apparatus. The controller 98 and the memory 106 are connected to enable exchanges of data.

The light source 60 is driven by a laser driving section 100 connected to the controller 98. At the light emission side of the light source 60, a wave plate 62 and a polarizing beam splitter 64 are arranged in this order along a light path away from the light source 60. The wave plate 62 provides a predetermined light path difference (phase difference) between orthogonal linear polarization components of a specified wavelength. The polarizing beam splitter 64 reflects light with a predetermined polarization direction and transmits light with a polarization direction orthogonal thereto.

At the light transmission side of the polarizing beam splitter 64, a beam expander 66, a shutter 68 and a transmission-type spatial light modulator 70 are arranged in this order along the light path away from the polarizing beam splitter 64. The beam expander 66 is a magnifying and collimating optical system. The shutter 68 can be moved into and withdrawn from (open and close) the light path. The spatial light modulator 70 modulates incident light at each of pixels arranged in a two-dimensional pattern. The shutter 68 is opened and closed (moved in the directions of arrow C) by driving by a shutter driving section 102, which is connected to the controller 98.

The spatial light modulator 70 is connected to the controller 98 through a pattern generator (not shown). The pattern generator generates patterns to be displayed at the spatial light modulator 70 in accordance with digital data which is supplied from the controller 98. The spatial light modulator 70 modulates laser light that is incident thereon, in accordance with the display pattern, and generates signal light. At the light transmission side of the spatial light modulator 70, a Fourier transform lens 72 is disposed. The Fourier transform lens 72 Fourier-transforms the signal light generated by the spatial light modulator 70 and focuses the same on a predetermined location (the sector 24) of the microfilm 10, which is retained by a film retention unit 74.

An image reading unit 108 is provided in the vicinity of a page retention unit 88, which will be described later. The image reading unit 108 is constituted with a scanner or the like that reads an image of a page retained by the page retention unit 88. The image reading unit 108 may be provided, for example, at an upstream side of the page retention unit 88 with respect to a conveyance direction of pages, such that a page is supplied to the page retention unit 88 after an image of the page has been read by the image reading unit 108. The image reading unit 108 is connected to the controller 98. Image data that has been read by the image reading unit 108 is converted to digital data by the controller 98, and the digital data of the page is memorized in the memory 106. The digital data of the page is memorized in the memory 106 in association with an identification code (for example, a document ID and a page ID or the like) for identifying the page.

The digital data of the page memorized in the memory 106 is read by the controller 98 when recording a digital data hologram of the page, and is provided to the pattern generator. When recording a digital data hologram of, for example, the photography certificate 30A shown in FIG. 3C, a display pattern (digital image) 70A, which represents the digital data in a bright-dark image, is generated from the digital data of the photography certificate 30A (document information of the page), and the display pattern 70A is displayed at the spatial light modulator 70.

At the light reflection side of the polarizing beam splitter 64, a wave plate 76 and a polarizing beam splitter 78 are arranged in this order along a light path away from the polarizing beam splitter 64. At the light reflection side of the polarizing beam splitter 78, a turnable mirror 92 that turns about a predetermined axis, and a pair of relay lenses 94 and 96 are arranged in this order along a light path away from the polarizing beam splitter 78. The turnable mirror 92 is driven to turn (turning in the directions of arrow B) by a mirror driving section 104 connected to the controller 98. The pair of relay lenses 94 and 96 relay light reflected by the turnable mirror 92 and irradiate the light, onto the predetermined location (the sector 24) of the microfilm 10 retained at the film retention unit 74, to serve as reference light.

At the light transmission side of the polarizing beam splitter 78, a wave plate 80 and a reflection mirror 82 are arranged in this order along a light path away from the polarizing beam splitter 78. At the light reflection side of the reflection mirror 82, a shutter 84 and a beam expander 86, which is a magnifying and collimating optical system, are arranged in this order along a light path away from the reflection mirror 82. The shutter 84 is opened and closed (moved in the directions of arrow A) by driving by the shutter driving section 102 connected to the controller 98.

The page retention unit 88 is provided at the light emission side of the beam expander 86. The page retention unit 88 retains a page of an original document that is to be photographed, such as a paper document. Pages of the original document are conveyed one at a time by an unillustrated feeding mechanism, and are sequentially retained at the page retention unit 88. Light emitted from the beam expander 86 is irradiated at the whole of the page retained at the page retention unit 88 (for example, the photography certificate 30A shown in FIG. 3C). Object light is reflected or dispersed from the document retained at the page retention unit 88 (reflected object light). At the reflected object light emission side, a Fourier transform lens 90 is disposed. The Fourier transform lens 90 focuses the reflected object light on a predetermined location (the sector 24) of the microfilm 10 retained by the film retention unit 74.

Next, a recording operation of the document recording apparatus shown in FIG. 9 will be described.

In the present exemplary embodiment, both an analog data hologram and a digital data hologram are recorded for each individual page. The order in which the holograms are recorded is not constrained: A digital data hologram may be recorded after an analog data hologram has been recorded, and an analog data hologram may be recorded after a digital data hologram has been recorded.

When an analog data hologram is to be recorded, the shutter 68 is closed and the shutter 84 is opened, and laser light is irradiated from the light source 60. The laser light oscillated from the light source 60 is regulated in polarization direction by the wave plate 62, and is incident on the polarizing beam splitter 64. The wave plate 62 regulates the polarization direction of the incident laser light such that all the incident light is reflected by the polarizing beam splitter 64 or such that light of a suitable intensity is reflected by the polarizing beam splitter 64. If there is a portion of light that passes through the polarizing beam splitter 64, this light is blocked by the shutter 68.

The light reflected by the polarizing beam splitter 64 is regulated in polarization direction by the wave plate 76, is incident on the polarizing beam splitter 78, and is split. Light that has transmitted through the polarizing beam splitter 78 (the P polarization) is converted to the S polarization by the wave plate 80, and is reflected by the reflection mirror 82. Here, the sequence of the wave plate 80 and the reflection mirror 82 may be reversed.

Light that has been reflected at the reflection mirror 82 and whose light path has been bent passes through the shutter 84, is converted to parallel light with a large diameter by the beam expander 86, and is irradiated at the whole of the page retained at the page retention unit 88. The object light is reflected or dispersed from the page retained at the page retention unit 88 (reflected object light). The reflected object light is Fourier-transformed and focused by the Fourier transform lens 90, and is irradiated onto the predetermined location (the sector 24) of the microfilm 10 retained at the film retention unit 74. In the example described hereabove, reflected object light with the S polarization is irradiated onto the sector 24.

Meanwhile, the light that has been reflected by the polarizing beam splitter 78 is reflected by the turnable mirror 92 in a predetermined direction in accordance with the turn angle of the turnable mirror 92. The light reflected by the turnable mirror 92 is relayed by the pair of relay lenses 94 and 96, and is irradiated at the predetermined location (the sector 24) of the microfilm 10 retained at the film retention unit 74 to serve as the reference light. In the example described hereabove, reference light with the S polarization is irradiated onto the sector 24. The reference light is irradiated onto the predetermined location (the sector 24) simultaneously with the reflected object light. At the location at which the reflected object light and the reference light are irradiated, the reflected object light and the reference light interfere, and an interference pattern that is formed is recorded as an analog data hologram.

When a digital data hologram is to be recorded, the shutter 68 is opened and the shutter 84 is closed, and laser light is irradiated from the light source 60. The laser light oscillated from the light source 60 is regulated in polarization direction by the wave plate 62, and is incident on the polarizing beam splitter 64. The laser light transmitted through the polarizing beam splitter 64 is converted to parallel light with a large diameter by the beam expander 66, passes the shutter 68, and is irradiated at the spatial light modulator 70.

At the spatial light modulator 70, a display pattern representing the digital data of the page retained at the page retention unit 88 is displayed as a bright-dark image. For example, if the photography certificate 30A shown in FIG. 3C is being retained at the page retention unit 88, the display pattern 70A, which corresponds with the digital data of the photography certificate 30A, is displayed at the spatial light modulator 70. The display pattern expresses, for example, zeros and ones of binary digital data with dark (black pixels) and light (white pixels).

The light incident on the spatial light modulator 70 is intensity-modulated in accordance with the display pattern, and signal light is generated. Here, the spatial light modulator 70 is set up, or a suitable wave plate is provided, such that the intensity-modulated signal light will be in the S polarization. The signal light that has been generated by being modulated at the spatial light modulator 70 is Fourier-transformed and focused by the Fourier transform lens 72, and is irradiated onto the predetermined location (the sector 24) of the microfilm 10 retained at the film retention unit 74.

Meanwhile, the light that has been reflected by the polarizing beam splitter 64 is regulated in polarization direction by the wave plate 76 and is incident on the polarizing beam splitter 78. The wave plate 76 regulates the polarization direction of the incident laser light such that all the incident light is reflected by the polarizing beam splitter 78 or such that light of a suitable intensity is reflected by the polarizing beam splitter 78. The light reflected by the polarizing beam splitter 78 is reference light in the S polarization. If there is a portion of light that passes through the polarizing beam splitter 78, this light is blocked by the shutter 84.

Light that has been reflected at the polarizing beam splitter 78 and whose light path has been bent is reflected by the turnable mirror 92 in a predetermined direction in accordance with the turn angle of the turnable mirror 92. The light reflected by the turnable mirror 92 is relayed by the pair of relay lenses 94 and 96, and is irradiated, at the predetermined location (the sector 24) of the microfilm 10 retained at the film retention unit 74, to serve as the reference light. In the example described hereabove, reference light with the S polarization is irradiated onto the sector 24. The reference light is irradiated onto the predetermined location (the sector 24) simultaneously with the signal light. At the location at which the signal light and the reference light are irradiated, the signal light and the reference light interfere, and an interference pattern that is formed is recorded as a digital data hologram.

In the present exemplary embodiment, as described above, the whole of a series of pages (the pages representing commencement 28, the pages representing the original 26 and the light source 32) is photographed, and recorded one sheet at a time in the analog data hologram format and in the digital data hologram format at the same sector 24 of the microfilm 10 (see FIG. 8). The photographed pages of the original document are conveyed one at a time by the unillustrated feeding mechanism and are sequentially retained at the page retention unit 88. Reflected object light and reference light are interfered for each page to record an analog data hologram, and signal light and reference light are interfered for each page to record a digital data hologram.

An analog data hologram and a digital data hologram of a single page may be multiplex-recorded in the same recording region (sector 24) of the microfilm 10 using the same reference light. Thus, document information of the same page is recorded as analog information and is also recorded as digital information in the same recording region. The analog information and the digital information coexist in the same recording region.

When an analog data hologram and a digital data hologram have been recorded using the same reference light, an analog image and digital data of the page may be replayed at the same time, using the same reference light as reading light. Thus, within a hologram in which an analog data hologram and a digital data hologram have been multiplex-recorded, it is assured that the page recorded as the analog data hologram is the same page as the page recorded as the digital data hologram. Therefore, even though the digital data hologram has been recorded on the basis of document information that has been converted to digital data, because the digital data hologram is associated with the analog image of the page, evidentiary quality of the digital data is assured by visual readability of the analog image replayed from the analog data hologram.

More specifically, the analog image of the page replayed from the analog data hologram is readable by a human, the same as an image of a page that is reduced and recorded in an analog format on a microfilm, and tampering is difficult. Further, because the digital data replayed from the digital data hologram is associated with the analog image of the page, by the reference light, evidentiary quality is assured. Herein, different reference lights may be employed by suitably modulating the reference light for an analog data hologram and a digital data hologram, or the like.

Analog data holograms and digital data holograms for the whole of a series of pages may be recorded by angle multiplexing at the same recording region of the microfilm 10 (for example, the sector 24), by, for example, turning the turnable mirror 92 and altering the incidence angle of the reference light for the different pages.

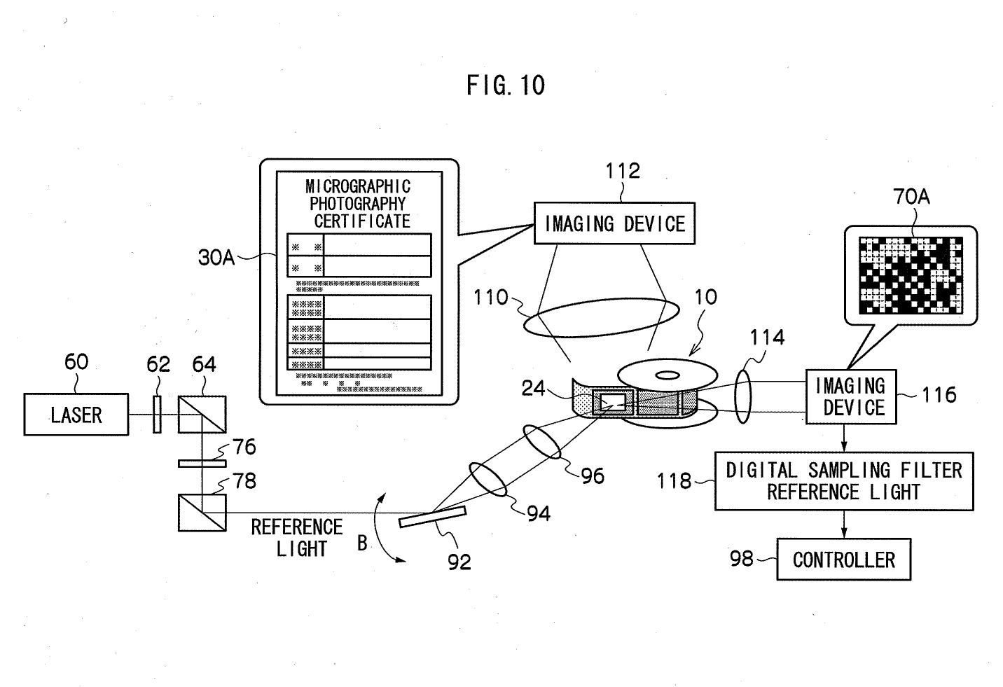

When recorded data is to be read (replayed), as shown in FIG. 10, a Fourier transform lens 110 and a sensor array 112, for detecting a replay image from the analog data hologram, and a Fourier transform lens 114 and a sensor array 116, for detecting a replay image from the digital data hologram, are disposed at the light transmission side of the microfilm 10. The shutters 68 and 84 are closed (see FIG. 9), and laser light is irradiated from the light source 60. The light is regulated and adjusted by the wave plates 62 and 76 and, because the shutters 68 and 84 are closed, other branches are blocked partway along their paths. Thus, only the reference light is irradiated onto the recording region (the sector 24) of the microfilm 10. In FIG. 10, only the light path of the reference light is shown and not omitted.

The laser light oscillated from the light source 60 is modulated in polarization direction by the wave plate 62, and is incident on the polarizing beam splitter 64. The light reflected by the polarizing beam splitter 64 is regulated in polarization direction by the wave plate 76, and is incident on the polarizing beam splitter 78. The light that has been reflected by the polarizing beam splitter 78 and whose light path has been bent is reflected by the turnable mirror 92 in a predetermined direction in accordance with the turn angle of the turnable mirror 92. The light reflected by the turnable mirror 92 is relayed by the pair of relay lenses 94 and 96, and is irradiated, on the predetermined location (sector 24) of the microfilm 10 retained at the film retention unit 74, as reference light for reading.

When the irradiated reference light passes through the recording region of the microfilm 10, it is diffracted by the recorded holograms, and transmitted and diffracted light is generated. The transmitted and diffracted light generated from the analog data hologram is irradiated toward the Fourier transform lens 110. The transmitted and diffracted light is reverse Fourier-transformed by the Fourier transform lens 110, and the reflected object light is replayed. The replayed reflected object light is incident on the sensor array 112. At a surface of the sensor array 112, the reflected object light is focused, and an analog image of the page is imaged. The sensor array 112 converts detected light to electronic signals and outputs the same. Thus, the analog image of the page is formed.

The transmitted and diffracted light generated from the digital data hologram is transmitted toward the Fourier transform lens 114. The transmitted and diffracted light is reverse Fourier-transformed by the Fourier transform lens 114, and the signal light is replayed. The replayed signal light is incident on the sensor array 116. At a surface of the sensor array 116, the signal light is focused, and a digital image of the page is imaged. The sensor array 116 converts detected light to electronic signals and outputs the same. Thus, the digital image of the page is formed.

The sensor array 116 is connected to the controller 98 through a digital sampling filter 118. As a result of the multiplex-recording of holograms, the digital image that is imaged by the sensor array 116 will include large amounts of noise. Therefore, the digital image is sampled and has noise removed by the Fourier transform lens 118, is then decoded to digital data, and the decoded digital data is outputted to the controller 98. The decoded digital data may be kept memorized in, for example, the memory 106, and may be suitably read out and utilized. For example, keyword searches, printouts and the like may be carried out using the digital data.

As has already been explained, the evidentiary quality of the digital data replayed from a digital data hologram is assured. Therefore, the evidentiary quality of memorized digital data may be certified for an individual page identified by an identification code or the like, by comparing the digital data memorized in the memory 106 with the digital data replayed from the digital data hologram.

When analog data holograms and digital data holograms of a plural number of pages have been multiplex-recorded at a recording region of the microfilm 10 (the sector 24), the two kinds of hologram of a page that is to be read (for example, the photography certificate 30A) are irradiated with reference light the same as at the time of recording. For example, if the holograms of the plural number of pages have been recorded by angle multiplexing, the turn angle of the turnable mirror 92 is adjusted and the reference light is irradiated on the recording region of the microfilm 10 with an incidence angle the same as when the two kinds of hologram of the photography certificate 30A were recorded. Accordingly, the analog image and the digital image of the photography certificate 30A are replayed.

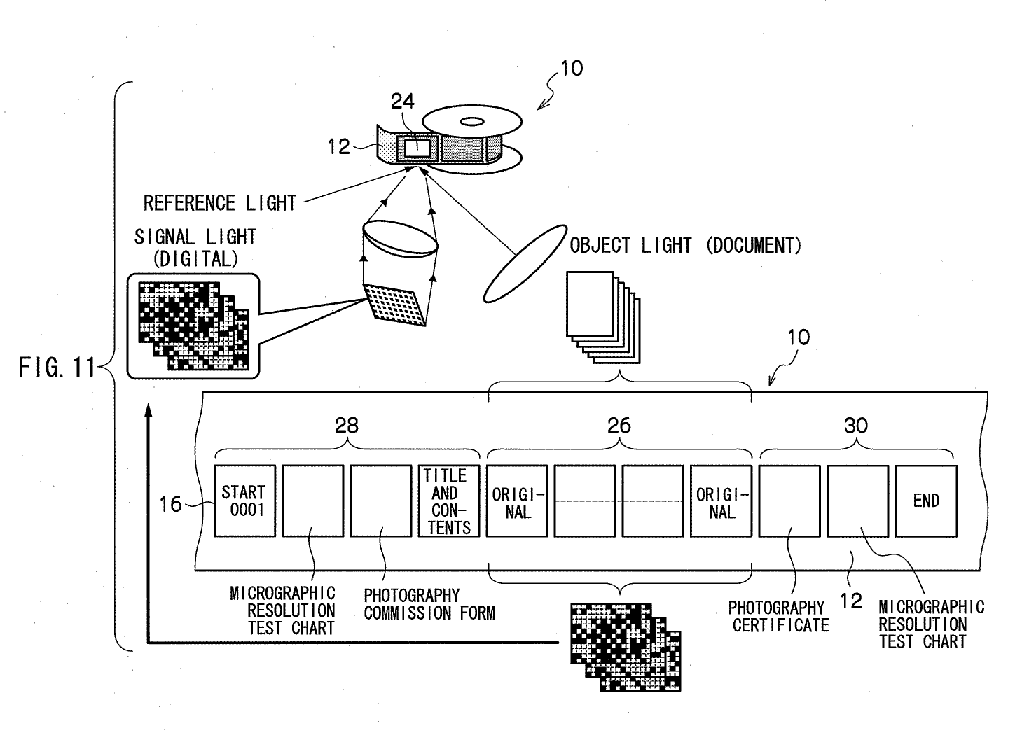

For the above-described second exemplary embodiment, an example has been described in which the whole of a series of pages (the pages representing commencement 28, the pages representing the original 26 and the pages representing conclusion 30) are multiplex-recorded on the same sector 24 of the microfilm 10 in the formats of analog data holograms and digital data holograms. However, as shown in FIG. 11, similarly to the first exemplary embodiment, a portion of a series of pages (the pages representing commencement 28 and the pages representing conclusion 30) may be recorded on the microfilm 10 in an analog format as in conventions, and just the pages representing the original 26 multiplex-recorded in the formats of analog data holograms and digital data holograms in the recording regions (sectors 24) between the frames of the pages representing commencement 28 and the frames representing the pages representing conclusion 30. Similarly to the first exemplary embodiment, tampering is more difficult in respect of visual readability.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. A document recording method for recording a document on a microfilm, the document comprising a series of pages for which a format is specified so as to include at least a page representing commencement, a page representing an original, and a page representing conclusion, the method comprising:
recording all or a portion of the series of pages on the microfilm in a hologram format obtained by interference between object light and reference light.

2. The document recording method of claim 1, wherein the recording includes multiplex-recording all or a portion of the series of pages in the hologram format at the same region of the microfilm.

3. The document recording method of claim 1, further comprising: recording the page representing commencement in an analog format at a first region of the microfilm; and recording the page representing conclusion in an analog format at a second region of the microfilm, which is different from the first region,
wherein the recording includes multiplex-recording of all of the page(s) representing the original in the hologram format at a third region of the microfilm, which is between the first region and the second region.

4. The document recording method of claim 1, wherein the recording includes recording all or a portion of the series of pages in an analog data hologram format, which replays an analog image of each page, at the same region of the microfilm.

5. The document recording method of claim 1, wherein the recording includes: recording all or a portion of the series of pages at the same region of the microfilm in an analog data hologram format, which replays an analog image of each page, and in a digital data hologram format, which replays a digital image that represents document information of each page in a bright-dark image.

6. A document recording apparatus for recording a document on a microfilm, the document comprising a series of pages for which a format is specified so as to include at least a page representing commencement, a page representing an original, and a page representing conclusion, the apparatus comprising:
a light source that emits coherent light;
a splitting unit that splits the coherent light emitted from the light source into two light beams;
an object light generation unit that irradiates one of the light beams split by the splitting unit at a page, which is to be recorded in an analog data hologram format, and generates reflected object light;
an object light irradiation unit that regulates a light path of the reflected object light generated by the object light generation unit and irradiates the reflected object light on the microfilm; and
a reference light irradiation unit that regulates a light path of the other light beam split by the splitting unit and irradiates this light beam, as reference light, at a position of the microfilm at which the reflected object light is irradiated, simultaneously with the reflected object light.

7. A document recording apparatus for recording a document on a microfilm, the document comprising a series of pages for which a format is specified so as to include at least a page representing commencement, a page representing an original, and a page representing conclusion, the apparatus comprising:
a light source that emits coherent light;
a splitting unit that splits the coherent light emitted from the light source into two light beams;
a signal light generation unit that
includes a spatial light modulator which employs a plurality of pixels and displays a digital image representing document information of a page, which is to be recorded in a digital data hologram format, in a bright-dark image, and which modulates incident light at each pixel in accordance with the displayed digital image,
causes one of the light beams split by the splitting unit to be incident on the spatial light modulator,
modulates the light beam in accordance with the digital image displayed at the spatial light modulator, and
generates signal light;
a signal light irradiation unit that regulates a light path of the signal light generated by the signal light generation unit and irradiates the signal light on the microfilm; and
a reference light irradiation unit that regulates a light path of the other light beam split by the splitting unit and irradiates this light beam, as reference light, at a position of the microfilm at which the signal light is irradiated, simultaneously with the signal light.

8. A document recording apparatus for recording a document on a microfilm, the document comprising a series of pages for which a format is specified so as to include at least a page representing commencement, a page representing an original, and a page representing conclusion, the apparatus comprising:
a light source that emits coherent light;
a splitting unit that splits the coherent light emitted from the light source into three light beams;
an object light generation unit that irradiates a first light beam split by the splitting unit at a page, which is to be recorded in an analog data hologram format, and generates reflected object light;
an object light irradiation unit that regulates a light path of the reflected object light generated by the object light generation unit and irradiates the reflected object light on the microfilm;
a reference light irradiation unit that regulates a light path of a second light beam split by the splitting unit and irradiates this light beam, as reference light, at a position of the microfilm at which the reflected object light is irradiated, simultaneously with the reflected object light;
a signal light generation unit that
includes a spatial light modulator which employs a plurality of pixels and displays a digital image representing document information of a page, which is to be recorded in a digital data hologram format, in a bright-dark image, and which modulates incident light at each pixel in accordance with the displayed digital image,
causes a third light beam split by the splitting unit to be incident on the spatial light modulator,
modulates the light beam in accordance with the digital image displayed at the spatial light modulator, and
generates signal light; and
a signal light irradiation unit that regulates a light path of the signal light generated by the signal light generation unit and irradiates this signal light at the position of the microfilm at which the reflected object light is irradiated, simultaneously with the reference light.

9. The document recording apparatus of claim 8, wherein the same page is multiplex-recorded in the analog data hologram format and the digital data hologram format at the same position using the same reference light, and a plurality of the pages are multiplex-recorded at the same position in the analog data hologram format and the digital data hologram format by an angle of the reference light being altered for each page.

10. The document recording apparatus of claim 9, wherein the microfilm includes a plurality of frames, each frame is divided into a plurality of sectors, and the plurality of the pages are multiplex-recorded in the analog data hologram format and the digital data hologram format at one of the plurality of sectors.

11. The document recording apparatus of claim 8, further comprising a first shutter that blocks the first light beam, and a second shutter that blocks the third light beam, wherein,
when a page is to be recorded in the analog data hologram format, the third light beam is blocked by the second shutter such that the signal light is not generated, and when the page is to be recorded in the digital data hologram format, the first light beam is blocked by the first shutter such that the reflected object light is not generated.

12. The document recording apparatus of claim 8 wherein, when a page is to be recorded in the analog data hologram format, the splitting unit splits the coherent light into the first light beam and the second light beam, and when the page is to be recorded in the digital data hologram format, the splitting unit splits the coherent light into the second light beam and the third light beam.

13. The document recording apparatus of claim 8 wherein, when a page is to be recorded in the analog data hologram format, the splitting unit splits the coherent light into the first light beam and the second light beam, the first light beam having a first intensity, and when the page is to be recorded in the digital data hologram format, the splitting unit splits the coherent light into the second light beam and the third light beam, the third light beam having a second intensity.

14. The document recording apparatus of claim 8, wherein the page representing commencement and the page representing conclusion are recorded on the microfilm in an analog format, and the page representing the original is recorded in the analog data hologram format and the digital data hologram format at a region between regions at which the page representing commencement and the page representing conclusion are recorded.

15. The document recording apparatus of claim 8, wherein all of the series of pages are recorded in the analog data hologram format and the digital data hologram format.

16. The document recording apparatus of claim 8, wherein the object light generation unit further includes a Fourier transform lens that Fourier-transforms the reflected object light.

17. The document recording apparatus of claim 8, further comprising an image reading section that reads an image of the page, a controller that converts the image that is read to the digital image, and a memory that memorizes the digital image, wherein,
when the page is to be recorded in the digital data hologram format, the controller obtains the digital image from the memory and provides the digital image to the spatial light modulator.
